(19) United States
(12) Patent Application Publication
(10) Pub. No.: US 2006/0011283 A1
(43) Pub. Date: Jan. 19, 2006

(54) Tire/wheel assembly

(76) Inventors: Akira Kuramori, Kanagawa (JP); Mitsuru Naito, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/529,495

(22) PCT Filed: Aug. 20, 2003
(86) PCT No.: PCT/JP03/10502

§ 371 Date: Mar. 29, 2005

(30) Foreign Application Priority Data
Nov. 14, 2002 (JP) 2002330827

(51) Int. Cl. B60C 17/04

(52) U.S. Cl. 152/520

(57) ABSTRACT

A tire/wheel assembly having a run-flat support (3) inserted into the cavity section of a pneumatic tire (2) coaxially with a rim, wherein the outer circumferential surface of the run-flat support (3) is coated with a resin layer (8) or at least a region on the inner circumferential surface of the pneumatic tire (2) facing the outer circumferential surface of the run-flat support (3) is coated with the resin layer (8). Alternatively, in a tire/wheel assembly having a run-flat support (3) inserted into the cavity section of the pneumatic tire (2) coaxially with the rim, a cover plate (10) rotatable in the circumferential direction is arranged on the outer circumferential surface of the run-flat support (3).

### TECHNICAL FIELD

The present invention relates to a tire/wheel assembly, and more specifically, relates to a tire/wheel assembly having run-flat durability enhanced.

### BACKGROUND ART

A plurality of technologies enabling emergency driving about several hundreds kilometers even when a pneumatic tire goes flat while driving a vehicle have been proposed to meet demands from the market. Among these many proposes, the Japanese Patent Laid-Open Publication No. 10(1998)-297226 has proposed a technology which enables run-flat driving by supporting the punctured tire with a core which is attached on a rim inside the cavity section of the pneumatic tire mounted on the rim. This run-flat support (core) is used in such a manner that an annular body structured coaxially with a rim is concentrically attached on the rim. Therefore, this run-flat support (core) can be used as it is substantially without adding any special modification to structures of existing wheels/rims and has an advantage of being acceptable without causing any confusion in the market.

When the tire/wheel assembly (wheel) having the aforementioned structure gets a flat tire, the vehicle runs in a run-flat state where an inner surface of the tire with internal pressure reduced is supported on an outer peripheral surface of the run-flat support. However, as run-flat running mileage increases, the inner surface of the tire and the run-flat support at this time are increasingly worn away or damaged, thus preventing the running after a while. As the tire/wheel assembly, therefore, one ensuring run-flat driving over as long mileage as possible is more excellent, and the tire/wheel assembly having such a property of high run-flat durability has been demanded.

For such a demand, the Japanese Patent Laid-Open No. 2001-163020 has proposed that a tank filled with a lubricant is provided inside a shell of the run-flat support. However, this propose requires to fill the tank with a great deal of liquid lubricant, and thereby an increase in weight is inevitable, which does not necessarily greatly contribute the run-flat durability. In addition, the tank is directly attached to the inside of the shell, which requires such a tough and complicated attachment structure that the tank cannot be detached during run-flat driving. In this regard, the weight is increased and costs increase due to the complexity. Moreover, the liquid lubricant flows inside the tank during driving to cause unbalance, thus causing deterioration of driving stability.

### DISCLOSURE OF THE INVENTION

An object of the present invention is to provide a tire/wheel assembly having the run-flat durability further enhanced with a simple structure.

An aspect of the present invention to achieve the above object is characterized in that, in a tire/wheel assembly having a run-flat support inserted into a cavity section of a pneumatic tire coaxially with a rim, an outer peripheral surface of the run-flat support is coated with a resin layer.

Similarly, another aspect of the present invention to achieve the aforementioned object is characterized in that, in a tire/wheel assembly having a run-flat support inserted into a cavity section of a pneumatic tire coaxially with a rim, at least a region of an inner peripheral surface of the pneumatic tire facing an outer peripheral surface of the run-flat body is coated with a resin layer.

Generally, resin has a lower friction coefficient than that of rubber of the tire body. Coating the outer peripheral surface of the run-flat support or the inner peripheral surface of the pneumatic tire with the resin layer as described above reduces the frictional resistance in the contact surface between the inner peripheral surface of the tire and the outer peripheral surface of the run-flat support during run-flat driving, thus suppressing progress of mutual wear or damage thereof. Accordingly, the run-flat durability can be enhanced. In this case, when the resin layer is provided on each of the outer peripheral surface of the run-flat support and the inner peripheral surface of the pneumatic tire, the run-flat durability can be further enhanced. Moreover, since only coating of the resin layer is performed, the weight is not substantially increased, and the structure is simple. In addition, the resin layer is solid and does not flow, and thereby the driveability is not disturbed.

Still another aspect of the present invention to achieve the aforementioned object is characterized in that, in a tire/wheel assembly having a run-flat support inserted into a cavity section of a pneumatic tire coaxially with a rim, a cover plate rotatable in the circumferential direction is arranged on the outer peripheral surface of the run-flat support.

Since the outer peripheral surface of the run-flat support is provided with the cover plate rotatable in the circumferential direction as described above, the inner surface of the tire comes into contact with the cover plate during run-flat driving and slides corresponding to the outer peripheral surface of the run-flat support with the cover plate interposed therebetween, thus suppressing the wear between the tire and the run-flat support or damage thereof. Accordingly, the run-flat durability can be enhanced. Moreover, since only adding of the solid cover plate is performed, the weight is not substantially increased, and the structure is simple. In addition, the added cover plate is solid and does not flow, and thereby the driveability is not disturbed.

### BRIEF DESCRIPTION OF THE DRAWINGS

FIG. 1 is a meridian cross-sectional view showing a main portion of a tire/wheel assembly according to an embodiment of the present invention.

FIG. 2 is a meridian cross-sectional view showing a main portion of a tire/wheel assembly according to another embodiment of the present invention.

FIG. 3 is a cross-sectional view showing an example of a resin layer used in the present invention.

FIG. 4 is a meridian cross-sectional view showing a main portion of a tire/wheel assembly according to still another embodiment of the present invention.

### BEST MODES FOR CARRYING OUT THE INVENTION

In the present invention, a run-flat support is formed as an annular body to be inserted in a cavity section of a pneumatic tire. This run-flat support is designed to be smaller than the inner diameter of the cavity section so that a certain distance is maintained between the outer peripheral surface thereof and the inner surface of the cavity section of the pneumatic tire, and the inner peripheral surface thereof is formed so as to be supported on the rim. This run-flat support is mounted on the wheel together with the pneumatic tire in a state of being inserted into the pneumatic tire to be formed into the tire/wheel assembly. When the pneumatic tire goes flat while a vehicle with this tire/wheel assembly attached thereto is running, the punctured and flat tire is supported on the outer peripheral surface of the run-flat support, thereby allowing run-flat driving.

The structure of the run-flat support is not particularly limited if the run-flat support has such a structure that allows the run-flat support to be attached to an existing rim substantially without modifying the rim. Preferably, the run-flat support is composed of the annular shell and the elastic rings as the main members. Specifically, the annular shell includes a continuous support surface formed on the outer peripheral side (outer diameter side) for supporting the punctured tire. The inner peripheral side (inner diameter side) thereof is formed into fork-shaped open legs with the both left and right sidewalls as legs. Preferably, the support surface on the outer peripheral side is formed so that the shape in the cross section orthogonal to the circumferential direction is a curve convex toward the outer diameter side. The number of convex portions on the outer peripheral side of the annular shell may be one or more. When the number of convex portions is equal to or more than two, the load to be supported during run-flat driving can be distributed to the plurality of convex portions, thereby enhancing the durability of the annular shell as a whole.

The elastic rings are attached to the end portions of the respective fork-shaped both legs on the inner diameter side of the annular shell and abut on both left and right rim sheets to support the annular shell. This elastic rings are composed of rubber or elastic resin to absorb shock and vibration which the annular shell receives from the punctured tire. In addition, the elastic rings prevent the annular shell from slipping corresponding to the rim seats and accordingly stably support the annular shell.

Since the run-flat support of the present invention is required to support the vehicle weight through the punctured tire, the support body and the annular shell in the case where the run-flat support is composed of the annular shell and the elastic rings are each made of a rigid material. As the constituent material thereof, metal, resin, or the like is used. Examples of the metal among these can be steel, aluminum, and the like. The resin may be either thermoplastic resin or thermosetting resin. Examples of the thermoplastic resin may be nylon, polyester, polyethylene, polypropylene, polystyrene, polyphenylene sulfide, ABS, and the like. Examples of the thermosetting resin may be epoxy resin, unsaturated polyester resin, and the like. The resin may be used independently, and moreover, the resin may be blended with reinforced fibers and used as the fiber reinforced resin.

In the present invention, the kind of resin used in a resin layer is not particularly limited. Examples thereof may be fluoroplastics, silicone resin, polyethylene resin, polypropylene resin, polyacetal resin, nylon resin, and the like, which are particularly excellent in lubricity. The method of coating with the resin is not particularly limited, and coating with the resin can be performed by resolving the resin with a solvent into a solution for application, by_melting the resin for application, by forming the resin into a sheet or film for attachment or adhesion, by coating by using thermal shrinkage.

Moreover, in the resin layer, preferably, microcapsules containing a lubricant are mixed and dispersed. When such microcapsules are mixed and dispersed, as the resin layer is worn away during run-flat driving, the microcapsules are sequentially exposed, and the lubricant is leached out little by little. It is therefore possible to suppress not only wear of the resin layer but also wear of the inner surface of the tire coming into contact with the resin layer or the run-flat support more effectively.

In the present invention, in the case where a cover plate is provided on the outer peripheral surface of the run-flat support so as to rotate in the circumferential direction, resin is suitable for a material of the cover plate, and preferably, fiber reinforced resin is used in particular. Moreover, it is preferable to interpose a lubricant or a bearing mechanism between the run-flat support and the cover plate. Examples of the bearing mechanism can be a ball bearing, roller bearing, and the like. Such a lubricant or bearing mechanism interposed therebetween provides smooth sliding of the cover plate on the run-flat support. Accordingly, it is possible to suppress not only wear of the run-flat support and cover plate but also wear of the inner surface of the tire more effectively.

Hereinafter, the present invention will be specifically described with reference to the drawings.

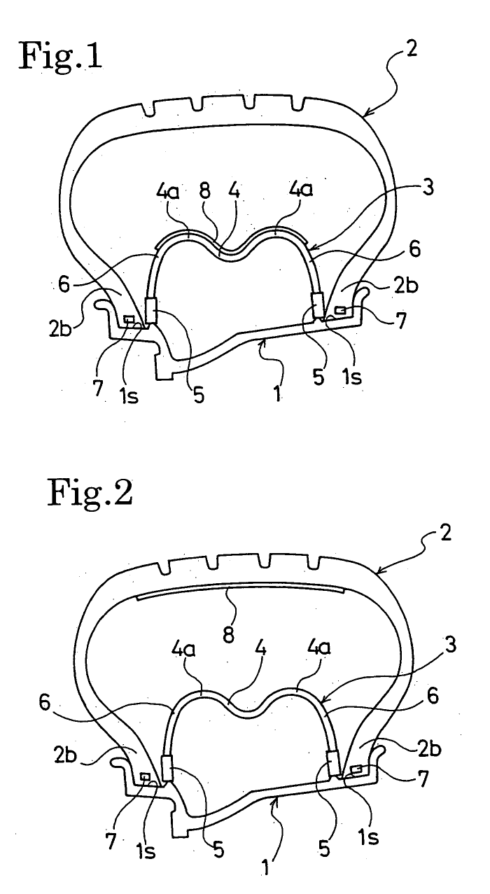

FIG. 1 is a cross-sectional view (meridian cross sectional view) in the tire width direction, showing a main portion of the tire/wheel assembly (wheel) according to an embodiment of the present invention.

Reference numerals 1, 2, and 3 denote a rim on the outer periphery of the wheel, a pneumatic tire, and a run-flat support, respectively. These rim 1, pneumatic tire 2, and run-flat support 3 are formed in annular shapes coaxially around a not-shown wheel rotation axis.

The run-flat support 3 includes an annular shell 4 formed of a rigid material such as metal or resin and elastic rings 5 formed of an elastic material such as hard rubber or elastic resin. The annular shell 4 is formed so that two convex portions 4a and 4b, each having a convex surface, are arranged side by side in the tire width direction on the outer peripheral side. The both sidewalls on the inner peripheral side of this annular shell 4 are opened in a fork-shape as legs 6 and 6 respectively. The elastic rings 5 and 5 are attached to end portions thereof. Furthermore, a resin layer 8 with low friction coefficient is provided on the outer peripheral surface of the annular shell 4 so as to cover the two convex portions 4a and 4b.

The run-flat support 3 configured as described above has the elastic rings 5 and 5 simultaneously attached to bead portions 2b and 2b and to rim sheets 1s and 1s of the rim 1 in the state where the run-flat support 3 is inserted into the pneumatic tire 2. In each of the bead portions 2b and 2b, an bead core 7 is annularly embedded along the tire circumferential direction. The embedded bead core 7 gives rigidity to the bead portion 2b. The bead core 7 is constructed by winding a steel wire annularly several times.

When the pneumatic tire 2 of the tire/wheel assembly having the aforementioned structure goes flat and the vehicle runs in a run-flat state, the inner surface of the pneumatic tire 2 repeatedly comes into contact with the outer peripheral surface of the run-flat support 3 every time the tire comes into contact with the ground, and the inner surface of the tire is increasingly worn away. However, the outer peripheral surface of the run-flat support 3 (that is, the outer peripheral surface of the annular shell 4) is coated with the resin layer 8 to reduce frictional resistance. Therefore, the progress of wear of the inner surface of the pneumatic tire 2 or the outer peripheral surface of the annular shell 4 is suppressed, and the mileage allowing run-flat driving can be increased.

FIG. 2 shows a main portion of a tire/wheel assembly (wheel) according to another embodiment of the present invention.

In this embodiment, the resin layer 8, which is provided on the side of the run-flat support 3 in the embodiment of FIG. 1, is provided on the side of the inner peripheral surface of the pneumatic tire 2. The other structures are the same as those of the case of FIG. 1. Also in this embodiment, the interposed resin layer 8 reduces the frictional resistance at the time of run-flat driving, and the progress of wear of the inner surface of the pneumatic tire 2 or the outer peripheral surface of the annular shell 4 is suppressed. Accordingly, the mileage allowing the run-flat driving can be increased.

The above resin layer 8 should be provided at least in a region of the inner peripheral surface of the pneumatic tire 2, corresponding to the outer peripheral surface of the annular shell 4. The resin layer 8 may be further extended to edges of the both beat portions so as to cover the entire inner surface. Moreover, it is possible to provide the resin layer 8 on the inner peripheral surface of the pneumatic tire 2 and simultaneously, as shown in FIG. 1, provide another resin layer 8 on the outer peripheral surface of the run-flat support 3 to be used together.

Generally, resin has a lower friction coefficient than that of rubber, and the kind of the resin of the resin layer 8 is not particularly limited. Examples thereof can be fluoroplastics, silicone resin, polyethylene resin, polypropylene resin, polyacetal resin, nylon resin, and the like as described above.

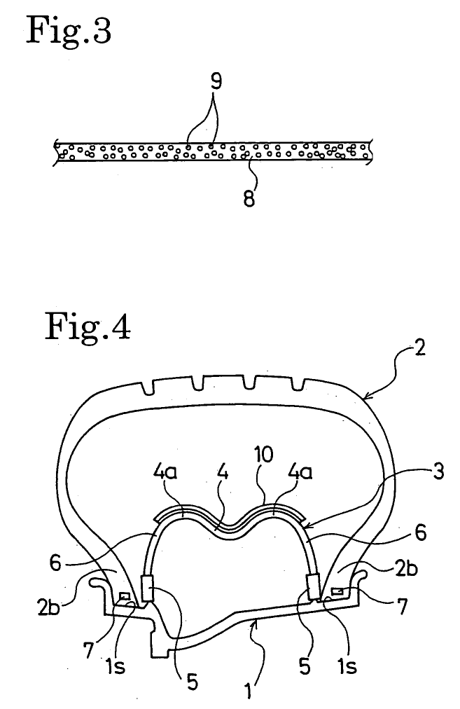

In the resin layer 8, preferably, a number of microcapsules 9 containing a lubricant are mixed and dispersed as shown in FIG. 3. When such microcapsules 9 are mixed as described above, as the resin layer 8 is worn away little by little during run-flat driving, the microcapsules 9 are sequentially exposed, and the lubricant is leached out. It is therefore possible to constantly maintain a satisfactory low friction coefficient.

FIG. 4 shows a main portion of a tire/wheel assembly (wheel) according to still another embodiment of the present invention.

In this embodiment, instead of the resin layer 8 in the embodiment of FIG. 1, a cover plate 10 rotatable in the circumferential direction is provided on the outer peripheral surface of the run-flat support 3. The cover plate 10 is, preferably, an annular body covering the entire circumference of the run-flat support 3 but may have a shape partially removed. Furthermore, it is preferable to interpose a lubricant or a bearing mechanism between the run-flat support 3 and the cover plate 10 to allow smooth sliding of the cover plate 10. The material of the cover plate 10 may be either resin or metal, and preferably, the cover plate 10 is made of resin for weight reduction.

In this embodiment, as in the cases of FIGS. 1 and 2, it is possible to suppress the progress of wear of the inner surface of the pneumatic tire 2 or the outer peripheral surface of the run-flat support 3 during run-flat driving and the mileage allowing the run-flat driving can be increased.

As described above, according to the present invention, the resin layer is provided on the outer peripheral surface of the run-flat support or the inner peripheral surface of the pneumatic tire. Accordingly, it is possible to reduce the frictional resistance in the contact surface between the inner surface of the tire and the outer peripheral surface of the run-flat support during the run-flat driving and to suppress the progress of mutual wear or damage thereof. According to another aspect of the present invention, the cover plate rotatable in the circumferential direction is provided on the outer peripheral surface of the run-flat support. Accordingly, the inner surface of the tire comes into contact with the cover plate during the run-flat driving and slides corresponding to the outer peripheral surface of the run-flat support with the cover plate interposed therebetween, thus suppressing wear between the tire and the run-flat support or damage thereof. Accordingly, the run-flat durability can be enhanced.

In each of the aspects of the present invention, only adding of the solid resin layer or cover plate is preformed. Accordingly, the weight is not substantially increased, and the structure thereof is simple. In addition, the added resin layer or cover plate is solid and does not flow, and thereby the driveability is not disturbed.

### EXAMPLES

A tire/wheel assembly (Example) having the run-flat support whose outer peripheral surface was coated with the resin layer of fluoroplastics as the structure shown in FIG. 1 and a tire/wheel assembly (Conventional Example) different from Example only in not having the resin layer were fabricated. The common tire size and rim size of each of the tire/wheel assemblies are 205/55R16 and 16×6 ½J, respectively.

The above two types of tire/wheel assemblies were measured by the following measurement method in terms of the run-flat durability thereof. As a result, the run-flat durability of Conventional Example was 100 (index) while that of Example was 115 (index), and the mileage allowing the run-flat driving was apparently increased in the Example.

[Run-Flat Durability]

A passenger car of 2500 cc displacement with a test tire/wheel assembly (air pressure: 0 kPa) attached to the front left side thereof was driven in a circuit by a test driver at a speed of 90 km/h. Note that when the other tires were used the air pressure was set to 200 kPa. The running mileage before the tire/wheel assembly got damaged was measured.

The evaluation is indicated by an index with the measured running mileage by use of the tire/wheel assembly of Conventional Example being defined as 100. A larger index means more excellent run-flat durability.

1. A tire/wheel assembly having a run-flat support inserted into a cavity section of a pneumatic tire coaxially with a rim, wherein
an outer peripheral surface of the run-flat support is coated with a resin layer.

2. A tire/wheel assembly having a run-flat support inserted into a cavity section of a pneumatic tire coaxially with a rim, wherein
at least a region of an inner peripheral surface of the pneumatic tire facing an outer peripheral surface of the run-flat support is coated with a resin layer.

3. The tire/wheel assembly according to claim 1, wherein
the run-flat support has a structure in which elastic rings are attached to end portions of open legs of an annular shell opened in a fork-shape.

4. The tire/wheel assembly according to claim 1, wherein
microcapsules containing a lubricant are mixed in the resin layer.

5. A tire/wheel assembly having a run-flat support inserted into a cavity section of a pneumatic tire coaxially with a rim, wherein
a cover plate rotatable in a circumferential direction is provided on an outer peripheral surface of the run-flat support.

6. The tire/wheel assembly according to claim 5, wherein
a lubricant and/or a bearing mechanism is interposed between the run-flat support and the cover plate.

7. The tire/wheel assembly according to claim 5, wherein
the run-flat support has a structure in which elastic rings are attached to end portions of open legs of an annular shell opened in a fork-shape.

8. The tire/wheel assembly according to claim 5, wherein
the cover plate is made of resin.

9. A run-flat support inserted into a cavity section of a pneumatic tire coaxially with a rim, wherein
the run-flat support has an outer peripheral surface coated with a resin layer.

10. A run-flat support inserted into a cavity section of a pneumatic tire coaxially with a rim, wherein
the run-flat support has an outer peripheral surface on which a cover plate is arranged to be rotatable in a circumferential direction.

11. The tire/wheel assembly according to claim 2 wherein
the run-flat support has a structure in which elastic rings are attached to end portions of open legs of an annular shell opened in a fork-shape.

12. The tire/wheel assembly according to claim 2, wherein
microcapsules containing a lubricant are mixed in the resin layer.
